(19) United States
(12) Patent Application Publication
(10) Pub. No.: US 2012/0079771 A1
(43) Pub. Date: Apr. 5, 2012

(54) BOTTOM SEAL FOR GARAGE DOOR

(75) Inventor: Michael J. Meulemans, North Muskegon, MI (US)

(73) Assignee: ISO-TRUDE, INC., Grand Haven, MI (US)

(21) Appl. No.: 13/248,125

(22) Filed: Sep. 29, 2011

Related U.S. Application Data
(60) Provisional application No. 61/388,240, filed on Sep. 30, 2010.

(51) Int. Cl. E06B 7/16

(52) U.S. Cl. 49/484.1; 49/495.1; 49/492.1

(57) ABSTRACT

A two-piece bottom seal assembly that adjusts to doors of different thicknesses during installation. The bottom seal assembly generally includes two frame components configured to close on the bottom of a door from opposite sides. The frame components are configured to interfit with one another at different fixed distances to accommodate doors of different thicknesses. In one embodiment, the frame components are generally L-shaped, each having a horizontal leg and a vertical leg. One of the two horizontal legs may include a pair of spaced walls that define a channel dimensioned to receive the other horizontal leg. The leg may include a head configured to interlock with corresponding features on the inside of the channel Each of the frame components may support a seal.

### BACKGROUND OF THE INVENTION

The present invention relates to overhead doors, such as garage doors, and more particularly to bottom seals for overhead doors.

Garages and other similar structures are often fitted with overhead doors, such as garage doors, that are opened and closed by raising and lowering them within a wall opening. When closed, the bottom of the door is typically brought into direct contact with the garage floor or a threshold. These types of doors often include a bottom seal that engages the garage floor or the threshold when the door is lowered. The bottom seal helps to seal the garage from the environment, keeping out rain, wind, cold, insects and other things.

Conventional garage door bottom seals are secured to the bottom of the door using a variety of different mechanisms. For example, some garage doors are provided with a channel or a pair of channels at the bottom of the door to receive the seal. The seal may include one or more heads that can be fitted into the channels. The channels may be formed in an extruded metal rail disposed at the bottom of the door. Alternatively, the channels may be cut into a wood rail positioned along the bottom of the door. As another example, bottom seals can be fastened to the bottom of the door using staples, screws or adhesives. The bottom seal is typically sized to match the length of the garage door. In some cases, the seal is flexible along its length and is provided in a roll. In such case, the seal can be unrolled and cut to length at the time of installation. In other cases, the seal is rigid and may be pre-cut to match the length of the door.

Garage doors are available in different thicknesses. For example, residential garage doors typically range from 1⅜ inches to 2½ inches. It is often desirable to match the bottom seal with the thickness of the door. Matching the bottom seal to the thickness of the door can create some issues. Conventionally, the garage door manufacturer or installer is required to stock seals in different thicknesses so that the correct seal can be used for each door. This results in increased cost of manufacture, increased cost of maintaining inventory and can be particularly problematic for on-site installation where it may be necessary to bring a variety of different size bottom seals to the job site.

### SUMMARY OF THE INVENTION

The present invention provides a two-piece bottom seal assembly that adjusts to doors of different thicknesses during installation. The bottom seal assembly generally includes two frame components that are configured to close on the bottom of a door from opposite sides. The frame components are configured to interfit with one another at different distances that accommodate doors of different thicknesses.

In one embodiment, the frame components are generally L-shaped, each having a horizontal leg and a vertical leg. The horizontal legs are configured to interfit at differing amounts to vary the overall thickness of the seal assembly. The vertical legs are configured to engage the inner and outer faces of the bottom of the door.

In one embodiment, the horizontal legs are configured to interlock with one another. In one embodiment, one of the two horizontal legs (i.e. the female leg) includes a pair of spaced walls that define a channel dimensioned to receive the other horizontal leg (i.e. the male leg). The male leg may be fitted into the channel the distance required for the frame components to close on the door. The male leg may include a head configured to interlock with corresponding features on the inside of the channel. For example, the walls that define the channel may include a plurality of internal ribs configured to interfit with the head. The arrangement of the ribs may be selected to allow the frame components to snap-together at a variety of nominal door thicknesses, such as 1⅜ inches, 1¾ inches and 2 inches. The male leg may include a head and a plurality of barbs that are arranged to simultaneously interfit within different ribs on the inside of the channel.

In one embodiment, each of the frame components supports a seal. For example, one frame component may carry a blade seal and the other frame component may carry a bulb seal. The bulb seal may be disposed on the bottom wall of the female leg and the blade seal may be disposed on the male leg where it does not interfere with the male leg being fitted into the channel.

In one embodiment, the seals are coextruded with the frame components. In this embodiment, the frame components may be manufactured from polymers in the same family. For example, the frame components may be rigid PVC and the seals may be flexible PVC. The two seals may be formed from the same material or from different materials.

In one embodiment, the frame components include apertures, such as screw holes or slots, for securing the frame components to the door. The screw holes or slots may be disposed on essentially any portion of the frame components. Vertical slots in the vertical legs may permit the bottom seal assembly to be adjusted along the length of the door to accommodate an uneven floor or threshold. As another option, one or both of the frame components may be manufactured with a groove and/or with indentations that provide a guide for forming screw holes during installation.

The present invention provides a simple and effective overhead door bottom seal assembly that can adjust to doors of different thicknesses. In embodiments with locking features, the frame components can be easily fitted onto the bottom of the door from opposite sides, and may in some cases remain installed without the aid of additional fasteners. The frame components can be provided with locking features that are specifically configured to lock at a variety of different standard door thicknesses. If desired, each frame component may support a seal, thereby providing a double seal arrangement that automatically adjusts to the door thickness with the frame components. In coextruded embodiments, the seals are integrated with the frame components and therefore do not require separate manufacture, assembly and installation. Further coextruded components may provide improved performance and extended life.

These and other objects, advantages, and features of the invention will be more fully understood and appreciated by reference to the description of the current embodiment and the drawings.

The invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1 is a perspective view showing a bottom seal assembly in accordance with an embodiment of the present invention installed on an overhead door.

FIG. 2 is an exploded perspective view of the bottom seal assembly and the door.

FIG. 3 is a side elevational view of the inner frame component.

FIG. 4 is a side elevational view of the outer frame component.

FIG. 5 is a side elevational view showing the frame components interlocked at a first distance.

FIG. 6 is a side elevational view showing the frame components interlocked at a second distance.

FIG. 7 is a side elevational view showing the frame components interlocked at a third distance and closed on a door.

FIG. 8 is a side elevational view of a first alternative bottom seal assembly.

FIG. 9 is a side elevational view of a second alternative bottom seal assembly.

### DESCRIPTION OF THE CURRENT EMBODIMENT

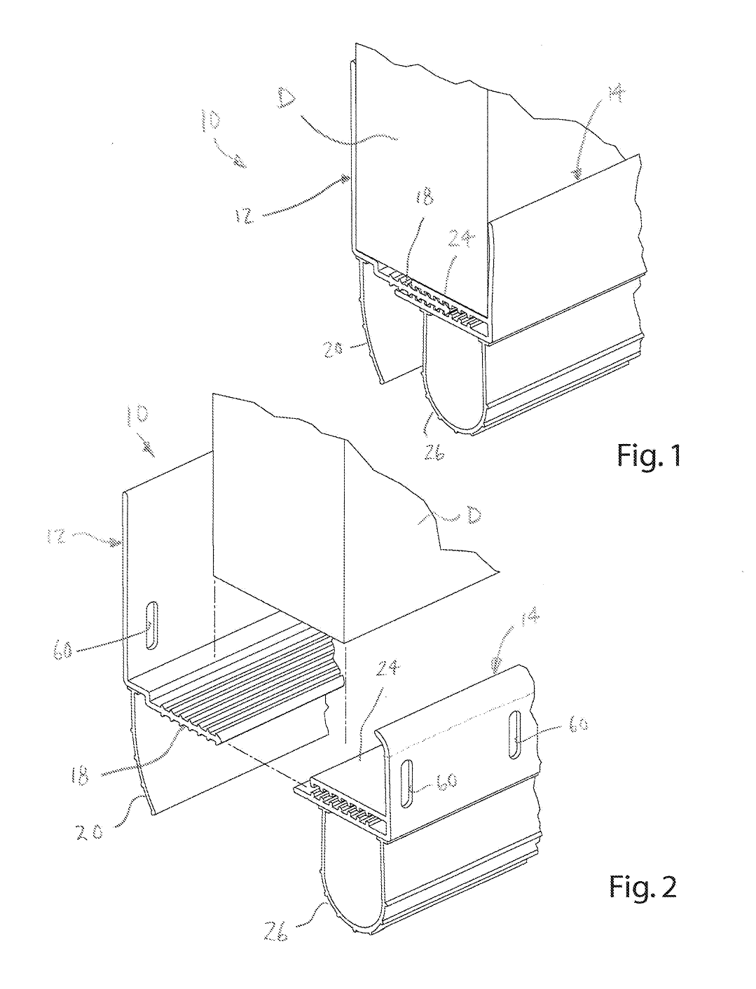

An overhead door bottom seal assembly in accordance with an embodiment of the present invention is shown in FIG. 1 and generally designated 10. The bottom seal assembly 10 includes an inner frame component 12 and an outer frame component 14. The frame components 12, 14 are configured to close on the bottom of the door D. In this embodiment, the inner frame component 12 includes a male horizontal leg 18 and the outer frame component 14 includes a female horizontal leg 24. The male leg 18 and female leg 24 are configured to interlock at a variety of different distances to accommodate doors of different thicknesses. The male leg 18 of the illustrated embodiment includes a head and a plurality of barbs that interlock with corresponding rails on the inside of the female leg 24. The head, barbs and rails may be angled to facilitate insertion of the male leg 18 into the female leg 24 and to resist separation of the male leg 18 from the female leg 24. In the illustrated embodiment, the inner frame component 12 carries a blade seal 20 and the outer frame component 14 carries a bulb seal 26. In use, the frame components 12, 14 are closed on the bottom of the door D with the male leg 18 fitted into the female leg 24. The frame components 12, 14 are push together driving the male leg 18 further into the female leg 24 until the size of the seal assembly 10 corresponds with the thickness of the door D. The frame components 12, 14 may be secured to the door D by screws or other fasteners. In some applications, it may be unnecessary to use fasteners.

For purposes of disclosure, frame component 12 is referred to as the inner frame component and frame component 14 is referred to as the outer frame component. The frame components 12, 14 may, however, be configured in reverse if desired. For example, if desired, the frame components 12, 14 may be closed on the door from the opposite direction—meaning that the inner frame component 12 closes on the door from the outside and the outer frame component 14 closed on the door from the inside. Further, the interfitting and interlocking features of the frame components may be reversed. For example, the inner frame component may include the female horizontal leg and the outer frame component may include the male horizontal leg.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to packages of any specific orientation(s).

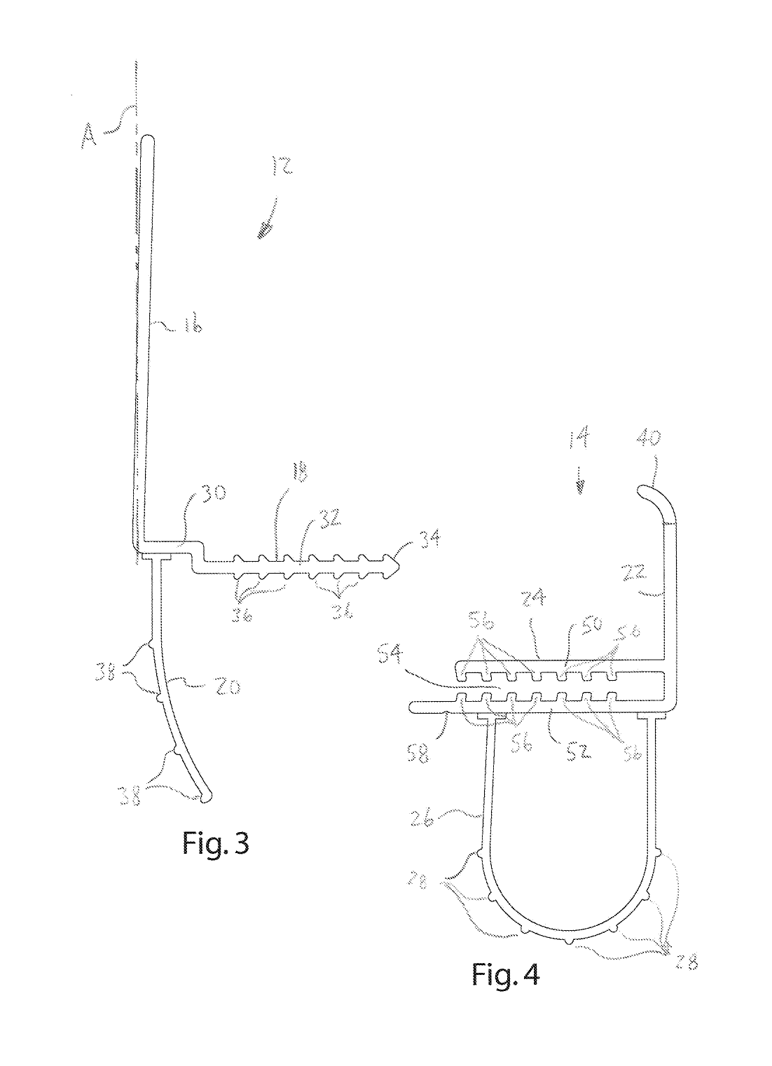

The inner frame component 12 of FIG. 1 is generally L-shaped including a vertical leg 16, a horizontal male leg 18 and a blade seal 20. The vertical leg 16 is configured to extend along the inner surface of the door D, and may be angled inwardly toward its upper end (as can be seen in FIG. 3 by reference to vertical line A) to provide improved engagement with the door D. The vertical leg 16 may be configured to flex outwardly into a vertical orientation when installed on the door D or it may be rigid and remain substantially angled even after installation. Although the vertical leg 16 is essentially planar in the illustrated embodiment, the shape of the vertical leg may vary from application to application. For example, the vertical leg may not be planar, but may instead be curved inwardly toward the door. Further, the vertical leg 16 need not be angled toward the door D. Although not shown, the upper end of the vertical leg 16 may include a seal to engage the door D. For example, a seal may be coextruded on the top of the vertical leg 16 or a separately manufactured seal may be fitted onto the top of the vertical leg 16.

The horizontal leg 18 of this embodiment includes a base portion 30 and an interlocking portion 32. The base portion 30 cooperates with the vertical leg 16 to define a corner that fits about the corner of the door D. The interlocking portion 32 is offset from the base portion 30 so that it is aligned with and can be fitted into the channel 54 in the female leg 24 of the outer frame component 14 (as described in more detail below). The interlocking portion 32 includes a head 34 and a plurality of barbs 36. The leading surfaces of the head 34 and the barbs 36 are tapered to facilitate insertion into the interlocking portion 32 of the female leg 24. The trailing surfaces of the head 34 and barbs 36 are angled to resist removal of the interlocking portion 32 from the female leg 24.

As noted above, the inner frame component 12 of the embodiment of FIG. 1 includes a blade seal 20. The blade seal 20 of this embodiment is carried by the base portion 30 of the male leg 18. More specifically, the blade seal 20 extends roughly downwardly from the base portion 30. In the illustrated embodiment, the blade seal 20 is curved inwardly along a relatively gradual curve. The blade seal 20 include a plurality of small ribs 38 that protrude a small distance from the ground-engaging surface of the seal 20. The design and configuration of the blade seal 20 may vary from application to application. For example, the blade seal may be of a different shape, may be secured to the inner frame component 12 at a different location and/or may extend from the inner frame component 12 at a different angle. Further, the ribs 38 may vary in number, size, shape and location. As described in more detail below, the blade seal 20 may be coextruded with the inner frame component 12 or may be separately manufactured and attached to the inner frame component 12.

As described above, the inner frame component 12 is configured to be interfitted with the outer frame component 14. The outer frame component 14 of FIG. 1 is generally L-shaped including a vertical leg 22, a horizontal leg 24 and a bulb seal 26 Like vertical leg 16, vertical leg 22 is configured to extend along a portion of the side of the door D. The vertical leg 22 and horizontal leg 24 may be oriented at approximately ninety degrees, but the angle may vary from application to application. For example, the angle may be less than ninety degrees so that the vertical leg 22 is inclined toward the door D at its upper end. The illustrated vertical leg 22 includes a lip 40 at its upper end. The lip 40 is configured to engage the door D to assist in providing a seal between the outer frame component 14 and the door D. The lip 40 of this embodiment is curved inwardly toward the door D, and may be manufactured from a material of sufficient flexibility to perform as a seal. In the illustrated embodiment, the lip 40 is coextruded with the outer frame component 14 and is formed from a material that is substantially more flexible and resilient than the main body of the frame component 14. Alternatively, the lip 40 may be an integral portion of the main body of the frame component 14 or it may be separately manufactured and installed on the vertical leg 22 after manufacture.

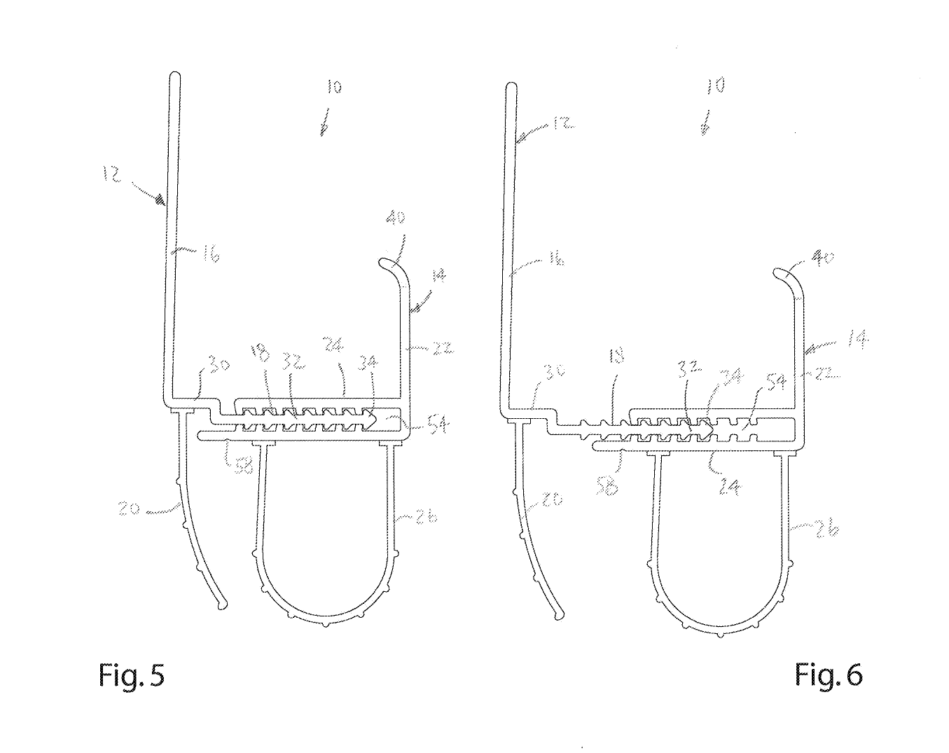

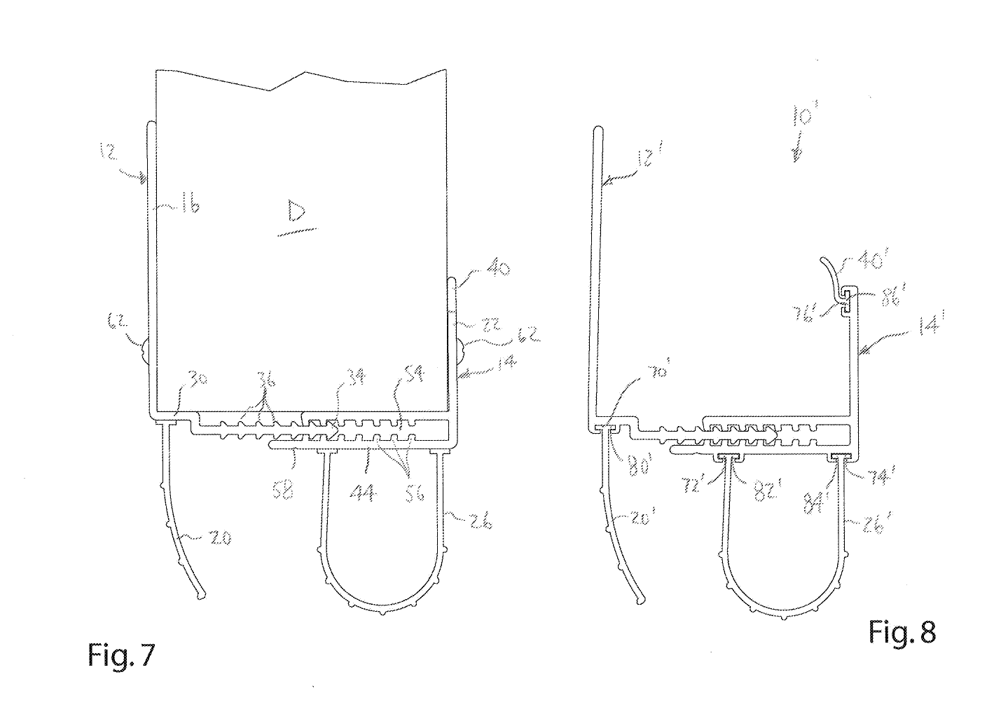

In this embodiment, the horizontal leg 24 of the outer frame component 14 is a female leg configured to receive the male leg 18 of the inner frame component 12. The horizontal leg 24 of this embodiment generally includes a top wall 50 and a bottom wall 52 that are spaced apart to define a channel 54. The top wall 50 and bottom wall 52 may include a plurality of ribs 56 arranged to interlock with the head 34 and barbs 36 of the male leg 18. More specifically, the ribs 56 are arranged in pairs, with a first rib on the top wall 50 and the second rib on the bottom wall 52 immediately across from the first. The female leg 24 of this embodiment includes seven pairs of ribs 56. However, the number of pairs of ribs may vary from application to application. In this embodiment, the ribs 56 are spaced regularly along the top and bottom walls 50, 52. As shown, the pairs of ribs 56 are spaced approximately 0.125 inches apart on center. This permits the seal assembly 10 to be easily adjusted at 0.125 inch intervals. For example, the illustrated embodiment is easily adjusted to fit doors with thicknesses of 1.375 inches (See FIG. 5), 1.750 inches (See FIG. 6) and 2.000 inches (See FIG. 7). The spacing between the pairs of ribs may, however, vary from application to application.

The ribs 56 may be shaped to facilitate insertion of the male leg 18 into the female leg 24, and may also be shaped to resist removal of the male leg 18 from the female leg 24. For example, in the illustrated embodiment, the leading surfaces of the ribs 56 (i.e. the surfaces that engage the head 34 and barbs 36 during insertion) and the trailing surfaces (i.e. the surfaces that engage the head 34 and barbs 36 during removal) are angled to perform these functions. More specifically, as shown in FIG. 5, the leading surfaces of the ribs 56 may be angled to interact with the leading surfaces of the head 34 and barbs 36 to urge the top wall 50 and the bottom wall 52 apart during insertion. The trailing surfaces of the ribs 56 may be angled so that they interact with the correspondingly-angled trailing surfaces of the head 34 and barbs 36 to pull the top wall 50 and the bottom wall 52 together to close on and resist removal of the male leg 18.

In the illustrated embodiment, the bottom wall 52 is somewhat longer than the top wall 50. A groove 58 may be formed in the exposed surface of the bottom wall 52 to provide an alignment guide for screws, if desired. For example, if it is desirable in a specific application to secure the bottom seal assembly 10 to the door D with a screw extending vertically through the male leg 18 and female leg 24, a screw may be installed through the groove 58.

As noted above, the outer frame component 14 includes a bulb seal 26. The bulb seal 26 is essentially a closed seal in the sense that it is secured to the frame component 14 along opposite longitudinal edges. Although the outer frame component 14 of the illustrated embodiment includes a bulb seal 26, the outer frame component 14 can alternatively include a different type of seal, and in some applications may include no seal at all. The bulb seal 26 is manufactured from a relatively soft and resilient material that can be compressed to form a seal when the door D is closed and that at least partially rebounds when the door D is opened. Like the blade seal 20, the bulb seal 26 may include a plurality of ribs 28 along its ground engaging surface.

In the illustrated embodiment, each frame component 12, 14 includes a seal. The seal arrangement may, however, vary from application to application. For example, if desired, both seals could be carried on the same frame component. In some applications, the bottom seal assembly may include a different number of seals. More specifically, in some applications, the bottom seal assembly may include a single seal or more than two seals.

The frame components 12, 14 may be provided with screw holes or slots 60 (See FIG. 2) that permit the bottom seal assembly 10 to be secured to the door D with fasteners, such as screws 62 (See FIG. 7). For example, as perhaps best shown in FIG. 2, the frame components 12, 14 may each include vertical slots 60, which allow them to be separately fastened to the door D. In the illustrated embodiment, regularly-spaced vertically-extending screw slots 60 are formed in the vertical legs 16, 22 of both frame components 12, 14 to allow them to be separately fastened to the door D by screws 62. The slots 60 provide vertical adjustability for the frame components 12, 14. This may allow the bottom seal assembly 10 to be more easily adjusted to match an uneven floor or uneven threshold. Alternatively, screw holes can be formed (e.g. drilled or punched) at the time of installation on the door D. In some applications, the interlock between the inner frame component 12 and the outer frame component 14 may be sufficient to secure the seal assembly 10 to the door D without additional mounting hardware. Alternatively (or in addition), the inner and outer frame components 12, 14 may be secured together and/or to the door D by adhesives.

The frame components 12, 14 may be manufactured from polymers using a coextrusion process that simultaneously forms the rigid and flexible portions. In the illustrated embodiment, the rigid portions of the frame components 12, 14 are manufactured from a rigid Polyvinyl chloride and the flexible portions of the frame components (i.e. the blade seal 20, bulb seal 26 and lip 40) are manufactured from a flexible Polyvinyl chloride. The materials may, however, vary from application to application. For example, the rigid portions of the frame components may be manufactured from Aluminum, Steel, Wood, Polypropylene, Polyethylene, ABS, Polycarbonate, Polystyrene and other rigid polymers, and the flexible portions of the frame components may be manufactured from Thermoplastic Elastomers/Olefins, Polyurethane, Rubber Compounds and other flexible polymers. The frame components of the illustrated embodiment are coextruded so it is desirable for the rigid portions and the flexible portions to be manufactured from materials that will adequately bond during the coextrusion process. For example, it may be desirable for the rigid portions and the flexible portions to be manufactured from materials in the same family of polymers. The flexible portions of the frame components need not be formed with the rigid components. Instead, the flexible portions may be separately manufactured and installed on the rigid components. For example, the flexible components may be secured to the rigid components by a friction fit, through mechanical interlock (e.g. ball and socket, tongue and groove) or by adhesives.

As noted above, the spacing of the interlocking features may be arranged so that the frame components 12, 14 firmly grip the bottom of the door D. For example, the spacing between the upper end of angled vertical wall 16 and the lip 40 may be smaller than the thickness of the door D. As a result, vertical wall 16 and lip 40 may flex when the door seal assembly 10 is closed on the door. The difference in size between nominal door thicknesses and the spacing between the vertical wall 16 and the lip 40 may be pre-selected to provide the appropriate amount of gripping force.

The illustrated embodiment includes interlocking barbs and ribs. The interlocking parts may vary from application to application. For example, the parts may mate using a tongue and groove arrangement or a ball and socket arrangement. The interlocking components may be eliminated in some applications. For example, the male leg may be fitted into the female leg without any interlocking components. In such embodiments, the male leg may be tightly fitted into the female leg so that friction helps to hold the frame components together. However, a frictional fit is not required and the frame components may be held together by adhesives or fasteners.

In use, the frame components 12, 14 are easily installed on the bottom of the door D. The inner frame component 12 and outer frame component 14 are closed on the bottom of the door D from opposite directions. The male leg 18 is fitted into the female leg 24 and the two from components 12, 14 are pushed together until the male leg 18 has been snapped-fitted into the female leg 24 the appropriate distance for the thickness of the door D. The vertical legs 16 and 22 will grip the bottom of the door D and the gripping force may be sufficient to hold the bottom seal assembly 10 in place during use. On the other hand, it may be desirable to use additional methods for securing the seal assembly 10 to the door D. For example, screws may be used to secure the frame components 12, 14. The screws may be installed horizontally through one or both of the vertical legs 16 and 22. Alternatively or in addition, screws may be installed vertically through one or both of the horizontal legs 18 and 24. Alternatively (or in addition), the frame components 12, 14 may be secured to the door D by adhesives.

Although the illustrated embodiment is coextruded from polymers, the frame components may be manufactured from essentially any suitable material using essentially any suitable manufacturing process. For example, the bottom seal assembly 10′ may include frame components 12′, 14′ extruded from aluminum, as shown in FIG. 5. In this exemplary embodiment, the frame components 12′, 14′ be formed with channels 70′, 72′, 74′ and 76′ configured to receive separately manufactured seals 20′, 26′ and 40′. In this embodiment, the seals 20′, 26′ and 40′ are manufactured with heads 80′, 82′, 84′ and 86′ that are configured to be slidably fitted into the channels 70′, 72′, 74′ and 76′. The seals 20′, 26′ and 40′ are separately manufactured from rubber or other suitably strong and flexible materials.

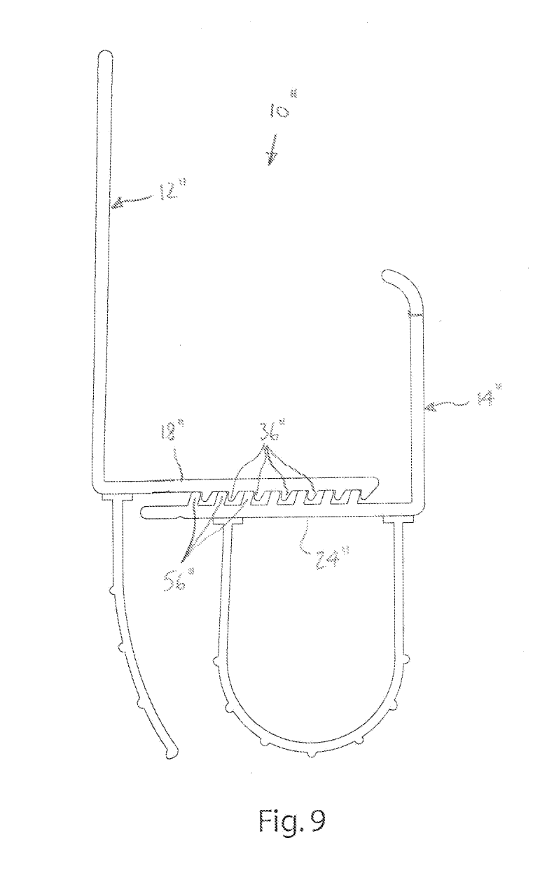

Although the frame components are described in connection with a male part that is fitted into a female part, the frame components may include alternative interfitting components. For example, the horizontal legs of the inner frame component and the outer frame component may be configured to overlap at different distances to accommodate different door thicknesses. The horizontal legs may be essentially planar so that they can freely overlap at essentially any distance. Alternatively, the horizontal legs may have mating ribs or other protrusions that essentially interlock the two frame components at one of a variety of fixed distances once secured to the door D. For example, FIG. 9 shows an alternative bottom seal assembly 10″ in which the inner frame component 12″ and outer frame component 14″ are configured to overlap. As shown, the inner frame component 12″ of this embodiment includes a horizontal leg 18″ with a plurality of ribs 36″ extending downwardly toward the outer frame component 14″. The outer frame component 14″ of this embodiment includes a horizontal leg 24″ with a plurality of upwardly extending ribs 56″. The two frame components 12″, 14″ may be overlapped a variety of different fixed distances dictated by the location and spacing of the ribs 36″ and 56″. The frame components 12″, 14″ may be secured in the desired overlapping relationship by screws extending through the frame components 12″, 14″ into the door.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

The embodiments of the invention in which an exclusive property or privilege is claimed are defined as follows:

1. A bottom seal assembly for an overhead door comprising:
a first frame component having a first door-engaging portion and a first interfitting portion;
a second frame component interfitted with the first frame component to close on an edge of the overhead door, said second frame having a second door engaging portion and a second interfitting portion, said second interfitting portion capable of being interfitted with said first interfitting portion at one of a plurality of different distances to selectively define a spacing between said first door-engaging portion and said second door-engaging portion, whereby the bottom seal assembly is capable of being fitted to overhead doors of differing thicknesses.

2. The bottom seal assembly of claim 1 wherein said first interfitting portion and said second interfitting portion are telescopically interfitted.

3. The bottom seal assembly of claim 2 wherein said first interfitting portion includes a pair of spaced-apart walls and said second interfitting portion includes a single wall fitted between said pair spaced-apart walls.

4. The bottom seal assembly of claim 3 wherein said spaced-apart walls and said single wall include a plurality of interlocking features to permit said single wall and said spaced-apart walls to interlock at a one of a plurality of different distances to selectively vary a distance between said first door-engaging portion and said second door-engaging portion.

5. The bottom seal assembly of claim 3 wherein said spaced-apart walls include a plurality of internal ribs and said single wall includes a head configured to interlock with said internals ribs.

6. The bottom seal assembly of claim 1 wherein said first frame component includes a first seal and said second frame component includes a second seal.

7. The bottom seal assembly of claim 6 wherein said first frame component includes a bulb seal and said second frame component includes a blade seal.

8. The bottom seal assembly of claim 7 wherein said first frame component and said bulb seal are coextruded.

9. The bottom seal assembly of claim 7 wherein said first frame component and said bulb seal are coextruded and said second frame component and said blade seal are coextruded.

10. The bottom seal assembly of claim 9 wherein said first frame component and said second frame component include apertures for securing said first frame component and said second frame component to the overhead door by fasteners.

11. A bottom seal assembly for an overhead door comprising:
a first frame component shaped to be fitted on an edge of the overhead door, said first frame component having a door-engaging leg and a connecting leg; and
a second frame component shaped to be fitted on an edge of the overhead door, said second frame component having a door-engaging leg and a connecting leg, said connecting leg of said first frame component and said connecting leg of said second frame component including interlocking features for selectively interlocking said first frame component and said second frame component in one a plurality of different configurations, each of said configurations causing said door-engaging leg of said first frame component and said door-engaging leg of said second frame component to be spaced-apart a different distance, whereby the bottom seal assembly is capable of being fitted to overhead doors of differing thicknesses.

12. The bottom seal assembly of claim 11 wherein said connecting leg of said first frame component includes a pair of spaced-apart walls and said connecting leg of said second frame component includes a single wall capable of being fitted between said pair spaced-apart walls.

13. The bottom seal assembly of claim 11 wherein said interlocking features includes a plurality of internal ribs on said spaced-apart walls and a head on said single wall, said internal ribs and said head configured to be snap-fitted.

14. The bottom seal assembly of claim 11 wherein said first frame component includes a first seal and said second frame component includes a second seal.

15. The bottom seal assembly of claim 11 wherein said first frame component includes a bulb seal and said second frame component includes a blade seal.

16. The bottom seal assembly of claim 15 wherein said first frame component and said bulb seal are coextruded and said second frame component and said blade seal are coextruded.

17. A seal assembly for an overhead door comprising:
an inner frame component being generally L-shaped and having an inner door-engaging leg and an inner connecting leg;
an outer frame component being generally L-shaped and having an outer door-engaging leg and an outer connecting leg, said inner connecting leg and said outer connecting leg capable of being selectively interfitted with said inner door-engaging leg and said outer door-engaging leg spaced-apart from one another at one of a plurality of different distances; and
interlocking features on said for selectively interlocking said inner connecting leg and said outer connecting leg in a plurality of discrete configurations, each of said configuration providing a different distance between said inner door-engaging leg and said outer door-engaging leg, whereby the seal assembly is capable of selectively interlocking onto overhead doors of differing thicknesses.

18. The seal assembly of claim 17 wherein one of said inner connecting leg and said outer connecting leg includes a pair of spaced-apart walls and the other of said inner connecting leg and said outer connecting leg includes a single wall capable of being fitted between said pair spaced-apart walls.

19. The seal assembly of claim 18 wherein said interlocking features includes a plurality of internal ribs on said spaced-apart walls and a head on said single wall.

20. The seal assembly of claim 19 wherein said connecting leg with said spaced-apart walls includes a bulb seal and said connecting leg with a single wall includes a blade seal.

21. The seal assembly of claim 19 wherein said outer frame component includes a bulb seal and said inner frame component includes a blade seal.

22. The seal assembly of claim 21 wherein said outer frame component and said bulb seal are coextruded and said inner frame component and said blade seal are coextruded.
